(19) United States
(12) Patent Application Publication
(10) Pub. No.: US 2014/0205123 A1
(43) Pub. Date: Jul. 24, 2014

(54) BALLOON CONNECTOR FOR A HEARING AID ASSEMBLY

(71) Applicant: Sonion Nederland B.V., Hoofddorp (NL)

(72) Inventors: Adrianus Maria Lafort, Delft (NL); Andreas Tiefenau, Koog a/d Zaan (NL); Erik Marinus Krom, Alkmaar (NL); Mads Buur Mortensen, Copenhagen N (DK); Flemming Risager, Naestved (DK)

(73) Assignee: Sonion Nederland B.V., Hoofddorp (NL)

(21) Appl. No.: 14/161,336

(22) Filed: Jan. 22, 2014

Related U.S. Application Data
(60) Provisional application No. 61/755,775, filed on Jan. 23, 2013.

(51) Int. Cl. H04R 25/00

(52) U.S. Cl. CPC H04R 25/652
USPC 381/329

(57) ABSTRACT

A hearing aid assembly comprising an inflatable ear dome, and in particular, a connector for connecting an inflatable ear-dome to a hearing aid.

### CROSS-REFERENCE To RELATED APPLICATION

This application claims the benefit of U.S. Provisional Patent Application No. 61/755,775, filed Jan. 23, 2013, entitled “Balloon Connector for a Hearing Aid Assembly” which is hereby incorporated by reference in its entirety.

### FIELD OF THE INVENTION

The present invention relates to a hearing aid assembly with inflatable ear dome. In particular, the present invention relates to a connector for connecting an inflatable ear-dome to a hearing aid.

### BACKGROUND OF THE INVENTION

Hearing aids are provided with ear domes to allow a smooth, comfortable fitting of the hearing aid inside the ear canal of a user. One way of providing an ear dome with enhanced comfort is an inflatable ear mold, such as a balloon. WO 2012/007508 shows such an ear mold system having ball-spout connection with an air inflation or pressure tube centred in the sound channel of the dome part. WO 2012/007067 shows an inflatable ear mold system with the air inflation tube provided separately aside of the ball-spout connection comprising the sound channel. Drawback of applying a ball-spout connection is inherently the freedom of movement of the bulb i.e. ball part of the connection. WO 2012/007187 shows a connector system applying two nozzle spouts for air inflation in addition to a central nozzle for sound transport.

The general problem of a Balloon connector is to provide an air-tight connection between a pump/valve system and the balloon as well as a sound-tight connection for the sound into the ear. Sound-tight means in that context that sound is delivered into the ear with reasonable low leakage losses (<3 dB) at 100 Hz (or 20 Hz for HiFi/wideband applications). Air tight means, that the balloon loses less than 20% of its' pressure difference to the environment by leakage through the connector over a time period of 16 hours.

### SUMMARY OF THE INVENTION

The invention provides a more robust and less complex means for connecting a dome to a hearing aid, enabling an air-tight and sound-tight connection. The above-mentioned object is complied with by providing, in a first aspect, a hearing aid connector assembly comprising a sound channel and an air pressure channel.

The hearing aid connector assembly comprises a male connector member and a female connector member. The male connector member comprises a cylindrical body having a centralized first sound channel, a first air pressure channel, and at least two thread-like protrusions. The female connector member comprises a cavity for receiving the cylindrical body of the male connector member, a second sound channel opening into the cavity, and a second air pressure channel. The cavity of the female connector comprises at least two slots for mating cooperation with the thread-like protrusions of the male connector, The second sound channel and the second air pressure channel are arranged such that when the male and female connector members are matingly engaged the first and second sound channel provide a continuous sound channel and the first and second air pressure channel constitute a continuous air pressure channel.

The slots of the female cavity are preferably L-shaped. This allows a bayonet-like connectivity with one major difference; after initial forward movement the thread-like protrusions cooperate with the slots in a screwing manner providing a tightening engagement of the connector parts. This facilitates air-tight sealing of the air-pressure channel,

### BRIEF DESCRIPTION OF THE DRAWINGS

The present invention will now be explained in further details with reference to the accompanying figures where

FIG. 1 shows a behind-the-ear hearing aid with an inflatable ear dome,

FIG. 2 is a cross-sectional view of a connector according to an embodiment of the invention,

FIG. 3 is a cross-sectional view of a connector according to another embodiment of the invention,

FIG. 4 is a cross-sectional view of a connector according to yet another embodiment of the invention,

FIG. 5A is a cross-sectional view of a connector according to yet another embodiment of the invention,

FIG. 5B is a cross-section along line B-B′ of FIG. 5A,

FIG. 6 shows first and second bayonet connector parts in perspective according to an embodiment of the invention,

FIG. 7 is a cross-section of the ear dome connector part of FIG. 6,

FIG. 8 is a cross-section of the ear dome connector part of FIG. 6 in perspective,

FIG. 9 shows first and second parts of another bayonet connector according to an embodiment of the invention,

FIG. 10 is a top view of the first bayonet connector part of FIG. 9,

FIG. 11 is a perspective view of an inflatable ear dome according to an embodiment of the invention,

FIG. 12 is a front view of the inflatable ear dome of FIG. 11,

FIGS. 13 and 14 show a first connector part according to an embodiment of the invention,

FIG. 15 shows a second connector part for cooperation with the first part according to FIGS. 13 and 14,

FIG. 16 and FIG. 17 show the first and second part of FIGS. 13-15 connectively assembly,

FIG. 18 shows an ear dome connector part and a balloon,

FIG. 19 shows the ear dome connector part and balloon of FIG. 18 in assembly,

FIG. 20 shows a cross-section of the assembly of FIG. 19,

FIGS. 21A-21D show various sealing geometries (tapered cross-section, square cross-section, raised ridge, concave shape) of the assembly of FIG. 19, and

FIGS. 22A-22C show several cross-sections of balloon sealing rings manufactured by different means.

While the invention is susceptible to various modifications and alternative forms, specific embodiments have been shown by way of examples in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DISCLOSURE OF THE DRAWINGS

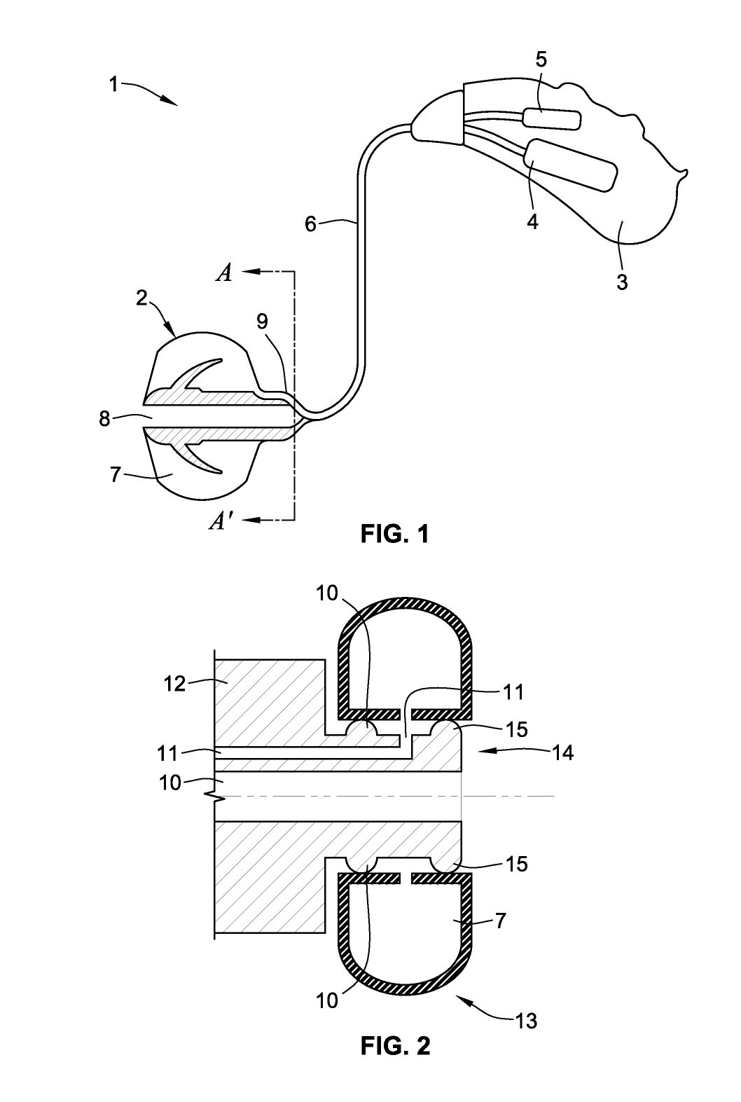

FIG. 1 shows a behind-the-ear (BTE) hearing aid 1 with an inflatable ear dome 2. The BTE part 3 comprises a receiver 4 which is arranged for outputting sound and a pump 5 for inflation of the ear dome 2. A connecting bi-lumen tube 6 guides sound through a first lumen to the ear dome and transfers air pressure provided by the pump through a second lumen for inflating the ear dome. The ear dome 2 consist of an inflatable balloon 7 positioned around a sound output channel 8. The air pressure lumen 9 ends into the balloon 7. The dotted line A-A′ shows a junction at which a connector is to be positioned in order to allow disconnecting and reconnecting a replaceable ear dome. The connector needs to provide both an air tight seal for pumping as well as a sound-tight seal for outputting sound.

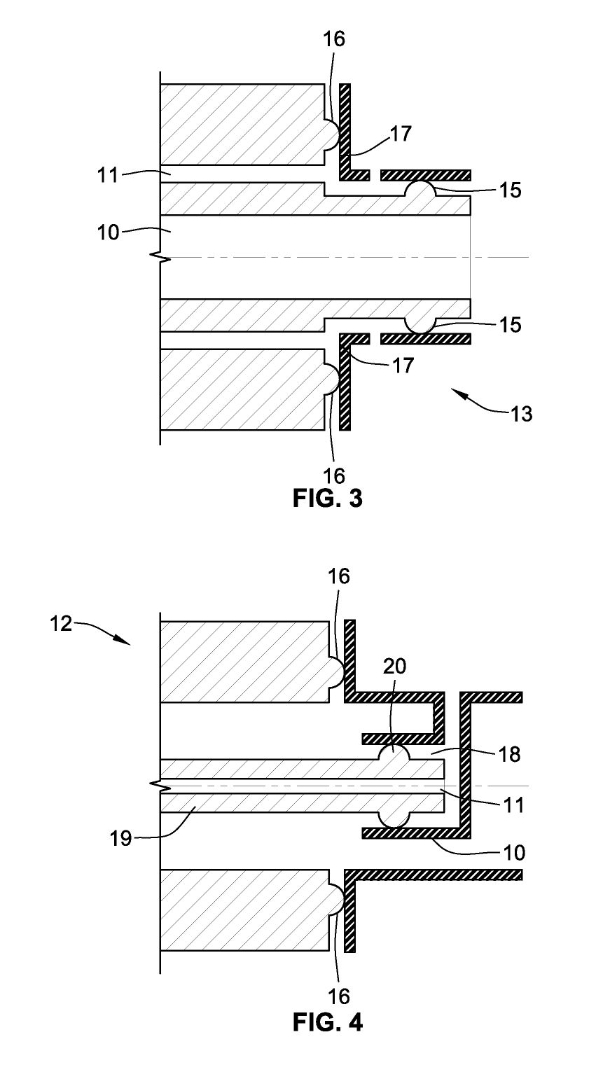

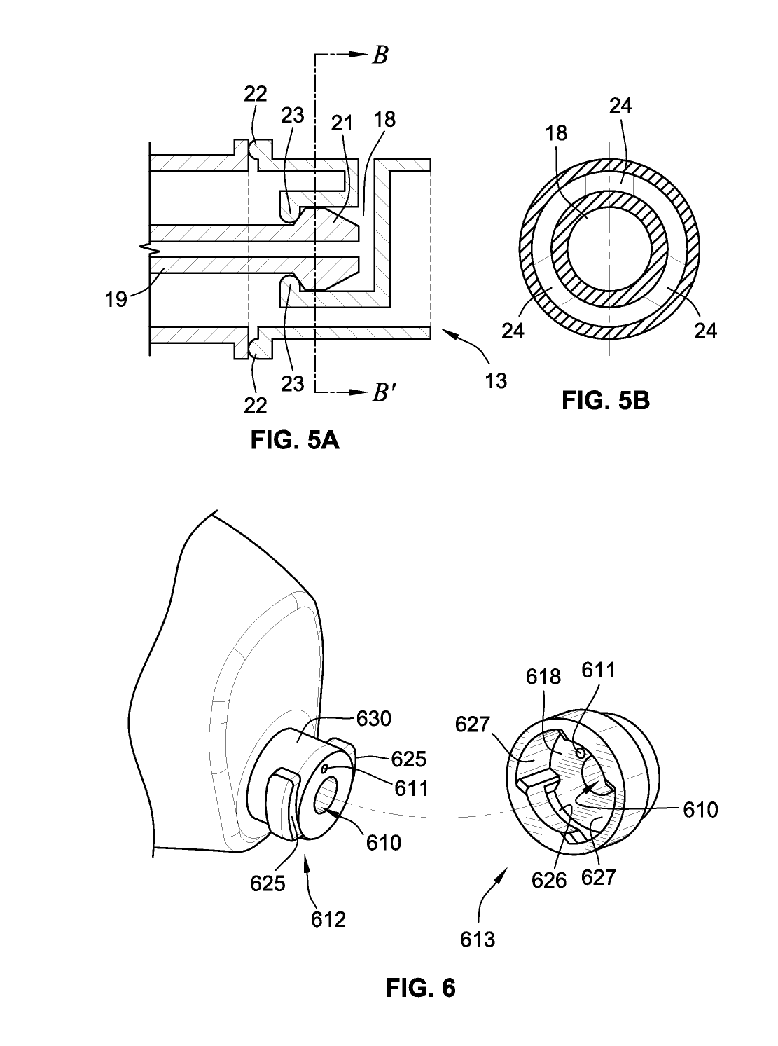

Referring now to FIGS. 2-5, these show various embodiments for arranging the sealing of a sound channel 10 and an air pressure channel 11. The channels are established when the connector is assembled. In FIG. 2 the sound channel 10 is in the centre of a lumen connector part 12 and the air pressure channel 11 runs alongside the sound channel 10 into the balloon 7 of the ear dome part 13. Alongside a cylindrical protruding portion 14 of the lumen connector part 12 two sealing rings 15, 16 are positioned along the circumference of the protruding portion 14. In FIG. 3 the distal sealing ring 15 is also positioned along the circumference of the protruding portion 14, but sealing ring 16 is now positioned on the surface extending around the protruding portion 14 and engages an outer contact surface 17 of the ear dome part 13. In FIG. 4 the arrangement of sound channel 10 and air pressure channel 11 is inverted. Thereto, the ear dome part 13 is provided with a centred female cavity 18 for receiving the male protruding portion 19 of the lumen connector part 12 carrying the air pressure channel 11. The male protruding portion 19 is provided with a sealing ring 20 engaging the inner surface of the female cavity 18. In FIG. 5A the male protruding portion 19 is provided with a bulb 21. Sealing rings are now provided on the ear dome portion 13: one sealing ring 22 on the contact surface 17 and one sealing ring 23 on the inner wall of the female cavity 18. The use of a bulb also provides a snap-fit function. FIG. 5B shows a cross section along the line B-B′ of FIG. 5A. In this example the female portion 18 is suspended in the centre by means of three spokes 24.

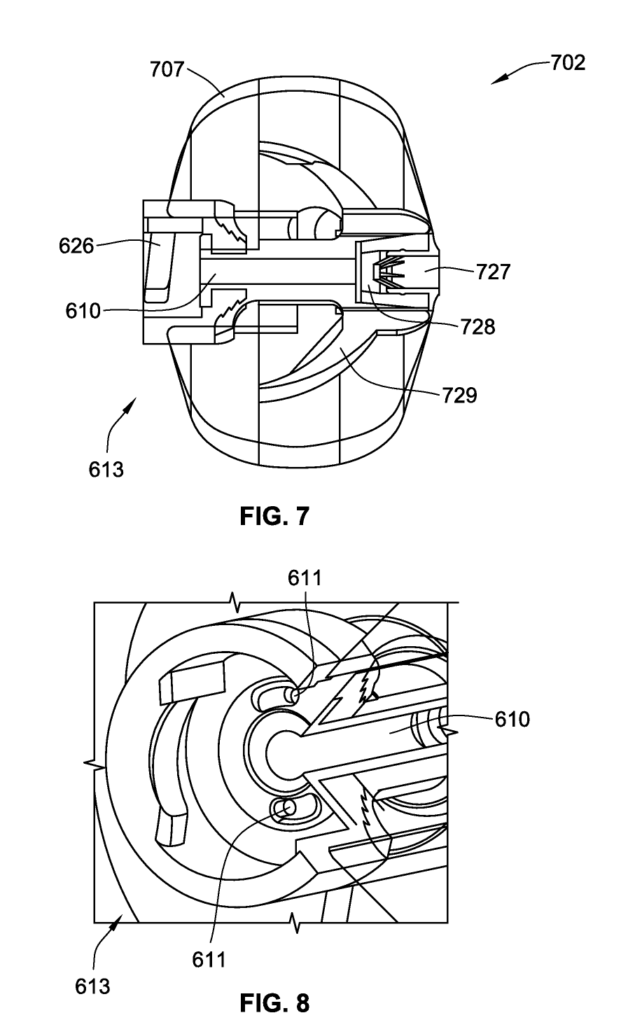

FIG. 6 shows a bayonet-like connector assembly consisting of two parts, the male lumen connector part 612 and the female ear dome connector part 613. The lumen connector part 612 has two pins or rims 625 protruding from a cylindrical body 630 that cooperate with two slots 627 of the ear dome connector part 613. The rims 625 are thread-like formed to allow tightening of the connection when rotated. The slots 627 are L-shaped for mating cooperation with the rims 625 which requires forward movement along a first track of the L-shape and consecutive turning to allow movement along the second part 626 of the L-shaped track 627. The second part 626 of the L-shaped track 627 and the rims 625 preferably are arranged for threading engagement. The male lumen connector part 612 carries first parts of the sound channel and the air pressure channel. The sound channel 610 runs centrally through the cylindrical body 630, the air pressure channel 611 is provided in the wall of the cylindrical body 630 running partially parallel with the sound channel 610. The female ear dome connector part 613 has a cavity 618 for receiving the cylindrical body 630 of the male lumen connector part 612. The female connector part carries second parts of the sound channel and the air pressure channel. Both the second sound channel and the second air pressure channel open into the cavity. When the connector parts 612, 613 are connected the air pressure channel 611 and the sound channel 610 are established. FIG. 7 shows the inflatable ear dome 702 with the ear dome connector part 613, the sound channel 610, slot 626 for engagement with bayonet rims, an ear wax guard 727 provided in the spout 728 of the sound channel 610, and an internal dome support structure 729 for supporting the balloon 707 when partially or fully deflated. FIG. 8 is a perspective view of the ear dome connector part 613 on the inside of the balloon 702 showing two air pressure channels 611 opening into the inside of the balloon.

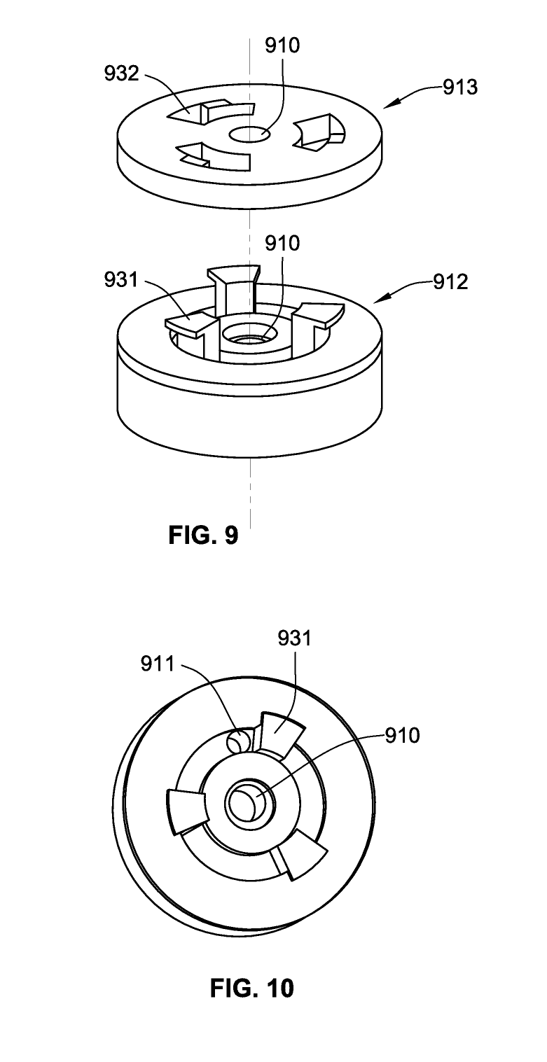

FIGS. 9 and 10 show an embodiment implementing another type of bayonet connector. In this embodiment, the lumen connector part 912 is provided with three protrusions 931 radially disposed around the sound channel 910 and adapted to cooperate with slots 932 of the ear dome connector part 913. The air pressure channel 911 is provided close to one of the protrusions 931 to allow transport air for pressurizing through one of the slots 932.

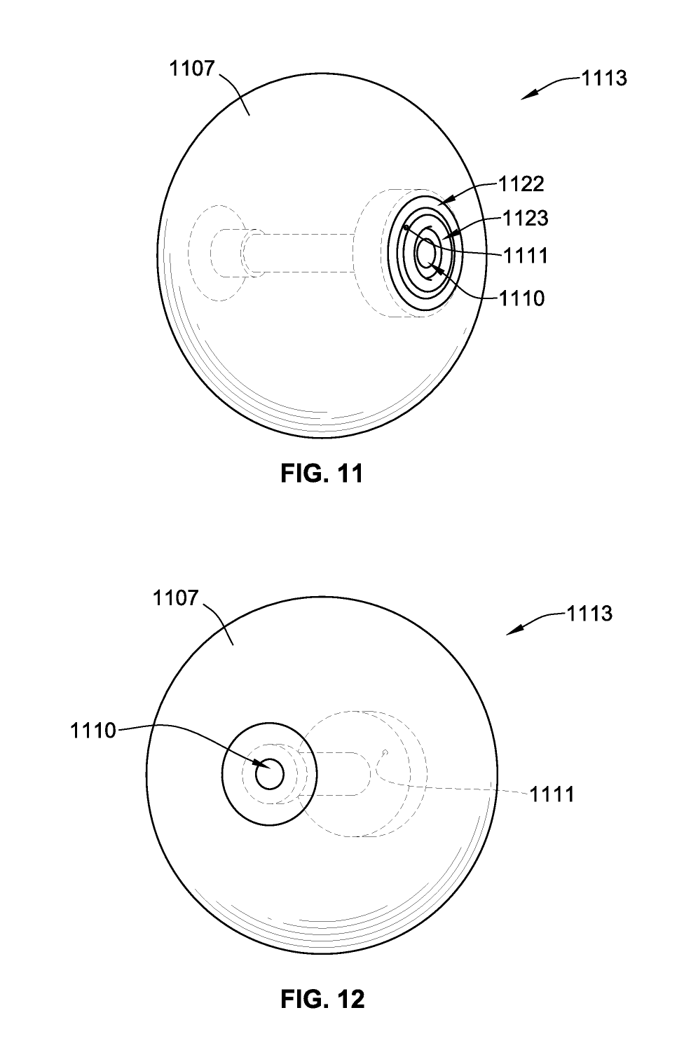

FIGS. 11 and 12 show an inflatable ear dome 1113 having a sealing arrangement consisting of two concentrically disposed rubber rings, an outer ring 1122 and an inner ring 1123. The air pressure channel 1111 is located between the outer and inner sealing rings 1122, 1123 for inflation of the balloon 1107. The sound channel 1110 is positioned within the inner ring 1123. When the ear dome connector part 1113 engages a lumen connector part, the sealing rings 1122, 1123 are compressed. The connector means may be of the bayonet type as described in relation to FIGS. 6-8 and 9-10, of the screwing type, or other locking means.

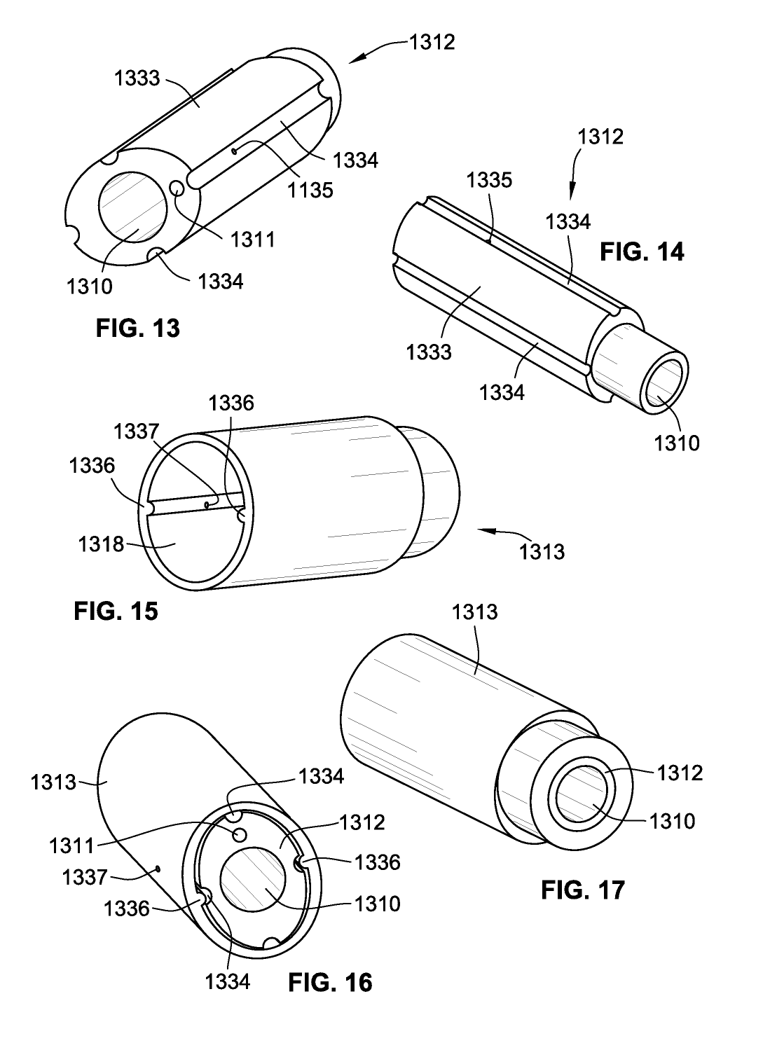

FIGS. 13 and 14 show a first connector part to be connective assembled with a second connector part shown in FIG. 15. In this embodiment, the first connector part is a male lumen connector part 1312 having an elongated body 1333 with an oval shaped cross-section. The elongated body 1333 is further provided with a sound channel 1310, an air pressure channel 1311 and four grooves 1334 running longitudinal over the elongated body. The air pressure channel 1311 terminates in one of the grooves 1334 in a first air pressure opening 1335. The second connector part is a female ear dome connector part 1313 made of an elastic material having a cavity 1318 for receiving the male lumen connector part 1312. The cavity 1318 is in cross-section oval shaped and provided with two ridges 1336 for cooperation with the four grooves 1334. One of the ridges 1336 is provided with a second air pressure opening 1337 to be aligned with the first air pressure opening 1335 when the connector parts 1312, 1313 are connectively assembled. FIGS. 16 and 17 show the lumen connector part 1312 and ear dome connector part 1313 in connective assembly. In order to connect the connector parts, the male part 1312 and female part 1313 are brought in a first position wherein their oval cross-section match and the ridges 1336 fall in a first corresponding pair of grooves 1334 and consecutively the female part is slid over the male part 1312. Next, the female part 131 and male part 1312 are brought in a second position by rotating either the female part 131 or male part 1312 over an angle of 90° such that the ridges 1336 fall in a next corresponding pair of grooves 1334. In the second rotated position wherein the oval shapes of male and female parts 1312, 1313 are unaligned the female part 1313 exerts a force due to the elastic properties of the material and provides a sealing effect. The ridge 1336 with air pressure holes 1337 and 1335 should be located such that they are aligned in the second position to establish the air pressure channel 1311.

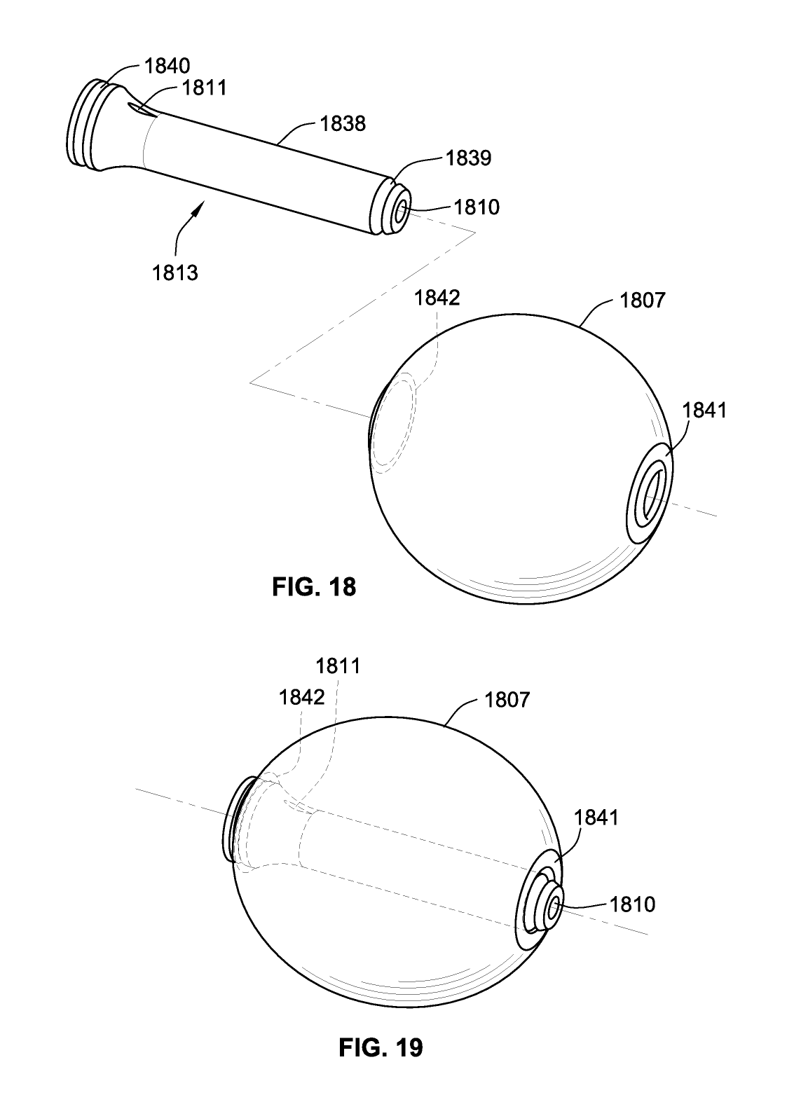

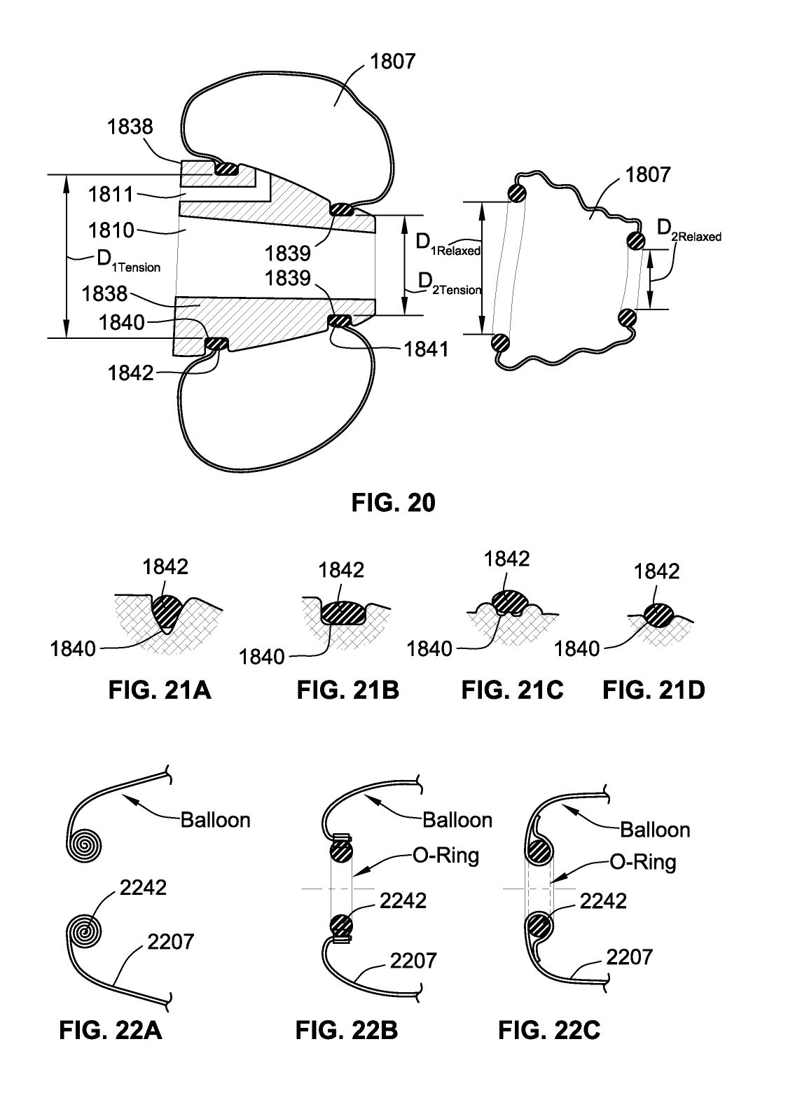

FIG. 18 shows a balloon 1807 and an ear dome connector part 1813. The ear dome connector part 1813 has a cylindrical body 1838 carrying a sound channel 1810 and air pressure channel 1811 terminating at the outer surface. The ear dome connector part 1813 is further provided with two annular fitting grooves 1839, 1840 on a distal and a proximal end respectively of the outer surface of the cylindrical body 1838. The balloon 1807 is provided with two sealing rings 1841, 1842 intended to fit the proximal and distal grooves 1839, 1840 of the ear dome connector 1813 as shown in FIG. 19. The sealing rings 1841, 1842 at the distal and proximal end are undersized compared to the diameter of the corresponding grooves 1839, 1840 of the ear dome connector part 1813. As can be seen in FIG. 20 the diameters of the rings in relaxed state, shown the right, are smaller than the rings in tensioned state, on the left. By stretching the sealing rings 1841, 1842 around the cylindrical body 1838, positioning them in the grooves 1839, 1840, the pre-tensioned rings will secure a reliable sealing between the balloon and the ear dome connector part 1813. Having created a reliable seal to the surrounding environment it is possible to inflate and deflate the balloon 1807 by pumping air into or out of the balloon through the air pressure channel 1811. The cross-sectional geometry of the grooves 1839, 1840 may be adapted to support the sealing performance. FIG. 21 A shows a tapered cross-section, FIG. 21B a square cross-section, FIG. 21C a raised ridge and FIG. 21D a concave shape.

FIGS. 22A-C show cross-sections of several balloon sealing rings manufactured by different means. FIG. 22A shows a sealing ring 2242 construed by rolling up the outer rim of the balloon material 2207, optionally enforced by gluing. FIG. 22B shows a sealing ring 2242 construed by an O-ring fixated to the outer rim of the balloon material 2207 e.g. by gluing. FIG. 22C shows a sealing ring 2242 construed by encapsulating an O-ring within the outer rim material of the balloon 2207.

While the present disclosure has been described with reference to one or more particular embodiments and implementations, those skilled in the art will recognize that many changes may be made thereto without departing from the spirit and scope of the present disclosure. Each of these embodiments and implementations and obvious variations thereof is contemplated as falling within the spirit and scope of the present invention, which is set forth in the claims that follow.

1. A hearing aid connector assembly comprising a male connector member and a female connector member,
the male connector member comprising a cylindrical body having a centralized first sound channel, a first air pressure channel, and at least two thread-like protrusions,
the female connector member comprising a cavity for receiving the cylindrical body of the male connector member, a second sound channel opening into the cavity, and a second air pressure channel, wherein the cavity comprises at least two slots for mating cooperation with the thread-like protrusions, wherein the second sound channel and the second air pressure channel are arranged such that when the male and female connector members are matingly engaged the first and second sound channel constitute a continuous sound channel and the first and second air pressure channel constitute a continuous air pressure channel.

2. A connector assembly according to claim 1, wherein either the male or the female connector member further comprises a balloon dome, and wherein the air pressure channel terminates inside the balloon dome.

3. A connector assembly according to claim 1, wherein the slots are L-shaped.

4. A connector assembly according to claim 2, wherein the slots are L-shaped.

5. A connector assembly according to claim 3, wherein the mating cooperation of the thread-like protrusions with the L-shaped slots is performed by a forward movement and consecutive screwing.

6. A connector assembly according to claim 4, wherein the mating cooperation of the thread-like protrusions with the L-shaped slots is performed by a forward movement and consecutive screwing.

7. A hearing aid comprising a receiver, a pump, a bi-lumen tube and a connector assembly according to claim 2, wherein the bi-lumen tube is arranged for connecting the receiver and the pump respectively to the sound channel and the air pressure channel of either one of the male and the female connector member.

8. A hearing aid comprising a receiver, a pump, a bi-lumen tube and a connector assembly according to claim 3, wherein the bi-lumen tube is arranged for connecting the receiver and the pump respectively to the sound channel and the air pressure channel of either one of the male and the female connector member.

9. A connector assembly according to claim 5 incorporated into a hearing aid that further includes a receiver, a pump, and a bi-lumen tube that is arranged for connecting the receiver and the pump respectively to the sound channel and the air pressure channel of either one of the male and the female connector member.
